(19) United States
(12) Patent Application Publication
(10) Pub. No.: US 2016/0108284 A1
(43) Pub. Date: Apr. 21, 2016

(54) POLISHING COMPOSITION

(71) Applicant: FUJIMI INCORPORATED, Kiyosu-shi, Aichi (JP)

(72) Inventor: Yukinobu YOSHIZAKI, Kiyosu-shi, Aichi (JP)

(73) Assignee: FUJIMI INCORPORATED, Kiyosu-shi, Aichi (JP)

(21) Appl. No.: 14/890,503

(22) PCT Filed: May 1, 2014
(86) PCT No.: PCT/JP2014/062099

§ 371 Date: Nov. 11, 2015

(30) Foreign Application Priority Data
May 15, 2013 (JP) 2013-103244

(51) Int. Cl. C09G 1/00

(52) U.S. Cl. CPC C09G 1/00

(57) ABSTRACT

An object of the present invention is to provide a means for improving a polishing rate and polishing selectivity of a phase-change compound.

The present invention is a polishing composition containing an organic compound having three or more hydroxy groups, at least one of an agent having a chelating action to at least one component of a phase-change compound and a brittle film forming agent, and an oxidizing agent.

### TECHNICAL FIELD

The present invention relates to a polishing composition, more specifically to a polishing composition suitable for polishing a polishing object containing a phase-change compound.

### BACKGROUND ART

A phase-change material (PCM) which can be electrically switched between an insulating amorphous phase and a conductive crystalline phase for an electronic memory application is used for a PRAM (phase-change random access memory) device (also known as an ovonic memory device or a PCRAM device). An element in group 16 (chalcogenide, for example, Te or Po) and an element in group 15 (for example, Sb) of the long-period periodic table are used in combination with one or more metal elements such as In, Ge, Ga, Sn, or Ag for a typical phase-change material suitable for these applications. A particularly useful phase-change material is a germanium (Ge)-antimony (Sb)-tellurium (Te) alloy (GST alloy). Physical conditions of these materials can reversibly change depending on a heating/cooling rate, temperature, and time. Examples of other useful alloys include indium antimonite (InSb). Memory information in the PRAM device is stored with minimizing loss by conduction characteristics of different physical phases or states.

Chemical mechanical polishing (CMP) is known as a method for polishing a metal-containing surface of a semiconductor substrate (for example, integrated circuit). A polishing composition used in CMP typically contains abrasive grains, an oxidizing agent, a complexing agent, or the like to perform polishing using etching effectively.

Such CMP can be used for manufacturing a memory device using a phase-change material. However, unlike a conventional metal layer formed of a single component such as copper (Cu) or tungsten (W), sulfur (S), cerium (Ce), germanium (Ge), antimony (Sb), tellurium (Te), silver (Ag), indium (In), tin (Sn), gallium (Ga), and the like are mixed in a phase-change material to be polished at a specific ratio. Physical properties of many phase-change materials (for example, GST) are different from those of conventional metal layer materials, for example, in that the phase-change materials are “softer” than other materials used in a PCM chip. Therefore, it is difficult to apply a conventional polishing composition for polishing a metal-containing surface as it is to polishing the phase-change material.

In such a situation, various studies have been performed on a polishing composition suitable for polishing a polishing object containing a phase-change compound. For example, JP 2009-016821 A (US 2009/001339 A) discloses a polishing composition for polishing a polishing object containing a phase-change compound containing abrasive grains and anitrogen compound. In addition, JP 2009-016829 A (U.S. Pat. No. 8,586,464) discloses a polishing composition for polishing a polishing object containing a phase-change compound containing abrasive grains and an iron ion or an iron chelate complex.

### SUMMARY OF INVENTION

However, in the technologies described in the above JP 2009-016821 A (US 2009/001339 A) and JP 2009-016829 A (U.S. Pat. No. 8,586,464), a polishing rate of a phase-change compound is insufficient, and improvement is desired. In addition, in the technologies described in the above JP 2009-016821 A (US 2009/001339 A) and JP 2009-016829 A (U.S. Pat. No. 8,586,464), a polishing rate of a material other than the phase-change compound, such as an insulating film, is also high, and therefore, a ratio of the polishing rate of the phase-change compound with respect to the polishing rate of a material other than the phase-change compound, that is, polishing selectivity is disadvantageously insufficient.

An object of the present invention is to provide a means for improving a polishing rate and polishing selectivity of a phase-change compound in a polishing composition used for polishing a polishing object containing the phase-change compound.

In order to solve the above problems, the present inventors have performed intensive studies. As a result, the present inventors have found that the above problems can be solved by a polishing composition containing an organic compound having three or more hydroxy groups, at least one of an agent having a chelating action to at least one component of a phase-change compound and a brittle film forming agent, and an oxidizing agent. The present inventors have completed the present invention based on the above knowledge.

That is, the present invention is a polishing composition containing an organic compound having three or more hydroxy groups, at least one of an agent having a chelating action to at least one component of a phase-change compound and a brittle film forming agent, and an oxidizing agent.

### DESCRIPTION OF EMBODIMENTS

The present invention is a polishing composition containing an organic compound having three or more hydroxy groups, at least one of an agent having a chelating action to at least one component of a phase-change compound and a brittle film forming agent, and an oxidizing agent. By such a configuration, a polishing composition having a polishing rate and polishing selectivity of a phase-change compound improved is obtained.

A detailed reason why the above effects can be obtained by using the polishing composition of the present invention is not known. However, a mechanism as follows is estimated. In the following mechanism, as a phase-change compound, a germanium (Ge)-antimony (Sb)-tellurium (Te) alloy (hereinafter, also simply referred to as GST alloy) will be exemplified.

First, an oxidizing agent reacts with a GST alloy, and germanium (Ge), antimony (Sb), and tellurium (Te) which are components of the GST alloy are oxidized. In a surface of the oxidized metal, hydration further occurs, and a surface hydroxy group is thereby generated. It is considered that a hydroxy group in an organic compound is dehydrated and condensed with this surface hydroxy group to generate a surface to be more easily polished. Dehydration condensation occurs more easily in an organic compound having more hydroxy groups in one molecule. Therefore, it is considered that a polishing rate of the GST alloy is easily raised by adding an organic compound having three or more hydroxy groups.

In addition, the organic compound does not increase electrical conductivity of abrasive grains, and therefore, does not change a mechanical polishing action of the abrasive grains. Therefore, a polishing rate of an insulating film does not change. A polishing composition having polishing selectivity of the GST alloy (phase-change compound) more improved is obtained.

The above mechanism is based on estimation. The invention is not limited in any way to the above mechanism.

Hereinafter, a configuration of the polishing composition of the present invention will be described in detail.

[Polishing Object]

The polishing composition of the present invention is used for polishing a polishing object containing a phase-change compound. The phase-change compound is used as a material which can be electrically switched between an insulating amorphous phase and a conductive crystalline phase for an electronic memory application in a PRAM (phase-change random access memory) device (also known as an ovonic memory device or a PCRAM device). Examples of the phase-change compound suitable for such an application include a combination of an element in group 16 (chalcogenide, for example, tellurium (Te) or polonium (Po)) and an element in group 15 (for example, antimony (Sb)) of the long-period periodic table with one or more metal elements such as indium (In), germanium (Ge), gallium (Ga), tin (Sn), or silver (Ag). A particularly useful phase-change compound is a germanium (Ge)-antimony (Sb)-tellurium (Te) alloy (GST alloy).

The polishing object may contain a material other than the phase-change compound. Examples thereof include a silicon-containing material used as an insulating film, such as TEOS (tetraethoxysilane) or SiN (silicon nitride).

[Organic Compound Having Three or More Hydroxy Groups]

The polishing composition according to the present invention contains an organic compound having three or more hydroxy groups (hereinafter, also simply referred to as organic compound). The organic compound is bonded to a hydroxy group formed on a surface of the phase-change compound by dehydration condensation, and improves polishing performance of the surface of the phase-change compound.

Specific examples of the organic compound include a polyhydric alcohol such as polyglycidol, glycerin, polyglycerin, trimethylolethane, trimethylolpropane, 1,3,5-pentatriol, erythritol, pentaerythritol, or dipentaerythritol; a sugar alcohol such as sorbitol, sorbitan, a sorbitol glycerin condensate, adonitol, arabitol, xylitol, mannitol, or maltitol; a sugar such as glucose, fructose, mannose, indose, sorbose, gulose, talose, tagatose, galactose, sucrose, lactose, allose, apiose, psicose, altrose, arabinose, ribulose, ribose, deoxyribose, fucose, xylose, xylulose, lyxose, idose, threose, erythrulose, erythrose, rhamnose, cellobiose, kojibiose, nigerose, sophorose, maltose, isomaltose, trehalose, isotrehalose, laminaribiose, gentiobiose, palatinose, coriose, sedoheptulose, glycyrrhizin, stevioside, mogroside, sucrose, raffinose, gentianose, melezitose, lactosucrose, maltotriose, isomaltotriose, sucralose, dextrin, cyclodextrin, glucosamine, mannosamine, galactosamine, N-acetyl glucosamine, N-acetylmannosamine, or N-acetylgalactosamine; a sugar acid such as glucuronic acid or galacturonic acid; ascorbic acid, glucuronolactone, and gluconolactone; monatin, monellin, and curculin; and a water-soluble polymer such as starch, glycogen, amylose, amylopectin, carboxymethyl starch, methyl hydroxypropyl starch, methyl cellulose, ethyl cellulose, methyl hydroxypropyl cellulose, hydroxyethyl cellulose, cellulose sodium sulfate, hydroxypropyl cellulose, carboxymethyl cellulose, cellulose, sodium alginate, propylene glycol alginate, or polyvinyl alcohol. In addition, derivatives such as partial-etherified compounds or partial-esterified compounds of these exemplified compounds and salts of these exemplified compounds are also suitable.

Among these organic compounds, at least one kind selected from the group consisting of glycerin, polyglycerin, erythritol, sorbitol, sorbitan, a sorbitol glycerin condensate, xylitol, glucose, fructose, mannose, galactose, sucrose, lactose, allose, apiose, psicose, ribulose, ribose, xylulose, erythrulose, erythrose, maltose, isomaltose, trehalose, isotrehalose, lactosucrose, maltotriose, isomaltotriose, sucralose, dextrin, cyclodextrin, glucosamine, galactosamine, glucuronic acid, galacturonic acid, ascorbic acid, glucuronolactone, gluconolactone, starch, glycogen, amylose, amylopectin, carboxymethyl starch, methyl hydroxypropyl starch, methyl cellulose, ethyl cellulose, methyl hydroxypropyl cellulose, hydroxyethyl cellulose, hydroxypropyl cellulose, carboxymethyl cellulose, cellulose, sodium alginate, and polyvinyl alcohol, is preferable. At least one kind selected from the group consisting of glycerin, sorbitol, sorbitan, a sorbitol glycerin condensate, xylitol, glucose, fructose, trehalose, dextrin, carboxymethyl cellulose, cellulose, and polyvinyl alcohol, is more preferable.

These organic compounds can be each used alone, or can be used by mixing two or more kinds thereof.

The lower limit of a content of the organic compound in the polishing composition is preferably 0.01% by weight or more, more preferably 0.1% by weight or more. A larger content of the organic compound can make a polishing rate and polishing selectivity of the phase-change compound higher.

The upper limit of the content of the organic compound in the polishing composition is preferably 10% by weight or less, more preferably 7.5% by weight or less. A smaller content of the organic compound can make it easier to handle the polishing composition itself and can make manufacturing cost of the composition lower.

[Agent Having Chelating Action and Brittle Film Forming Agent]

The polishing composition of the present invention contains at least one of an agent having a chelating action to at least one component of the phase-change compound and a brittle film forming agent. These agents further raise a polishing rate by acting on the surface of the phase-change compound.

[Agent Having Chelating Action]

The polishing composition of the present invention can contain an agent having a chelating action to at least one component contained in the phase-change compound. The agent having a chelating action chemically etches the surface of the phase-change compound by forming a complex with the surface of the phase-change compound to generate a water-soluble complex, and improves the polishing rate by the polishing composition.

Examples of the agent having a chelating action, which can be used, include an organic acid, amino acid, a nitrile compound, and a chelating agent other than these compounds. Specific examples of the organic acid include oxalic acid, malonic acid, succinic acid, glutaric acid, adipic acid, pimelic acid, maleic acid, phthalic acid, malic acid, tartaric acid, and citric acid. A salt such as an alkali metal salt of an organic acid may be used in place of the organic acid or in combination with the organic acid.

Specific examples of the amino acid include glycine, α-alanine, β-alanine, N-methylglycine, N,N-dimethylglycine, 2-aminobutyric acid, norvaline, valine, leucine, norleucine, isoleucine, phenylalanine, proline, sarcosine, ornithine, lysine, taurine, serine, threonine, homoserine, tyrosine, bicine, tricine, 3,5-diiodo-tyrosine, β-(3,4-dihydroxyphenyl)-alanine, thyroxine, 4-hydroxy-proline, cysteine, methionine ethionine, lanthionine, cystathionine, cystine, cysteic acid, aspartic acid, glutamic acid, 5-(carboxymethyl)-cysteine, 4-aminobutyric acid, asparagine, glutamine, azaserine, arginine, canavanine, citrulline, δ-hydroxy-lysine creatine, histidine, 1-methyl-histidine, 3-methyl-histidine, and tryptophan.

Specific examples of the nitrile compound include acetonitrile, aminoacetonitrile, propionitrile, butyronitrile, isobutyronitrile, benzonitrile, glutarodinitrile, and methoxy acetonitrile.

Specific examples of the chelating agent other than these compounds include iminodiacetic acid, nitrilotriacetic acid, diethylenetriamine pentaacetic acid, ethylenediamine tetraacetic acid, N,N,N-trimethylene phosphonic acid, ethylenediamine-N,N,N′,N′-tetramethylene sulfonic acid, transcyclohexanediamine tetraacetic acid, 1,2-diaminopropane tetraacetic acid, glycol ether diaminetetraacetic acid, ethylenediamine orthohydroxyphenylacetic acid, ethylenediamine disuccinic acid (SS body), N-(2-carboxylate ethyl)-L-aspartic acid, β-alanine diacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid.

Among these agents having a chelating action, an organic acid such as oxalic acid, malonic acid, succinic acid, glutaric acid, adipic acid, maleic acid, phthalic acid, malic acid, or citric acid; an amino acid such as glycine, alanine, valine, leucine, phenylalanine, proline, lysine, taurine, bicine, tricine, cysteine, methionine, cystine, cysteic acid, aspartic acid, 4-aminobutyric acid, asparagine, glutamine, arginine, histidine, or tryptophan; a nitrile compound such as acetonitrile or benzonitrile; iminodiacetic acid, ethylenediamine tetraacetic acid, and N-(2-carboxylate ethyl)-L-aspartic acid are particularly preferable.

These agents having a chelating action can be each used alone, or can be used by mixing two or more kinds thereof.

The lower limit of a content of the agent having a chelating action in the polishing composition is preferably 0.01% by weight or more, more preferably 0.1% by weight or more. A larger content of the agent having a chelating action brings about a higher etching effect to the phase-change compound. As a result, the polishing rate by the polishing composition is further improved.

On the other hand, the upper limit of the content of the agent having a chelating action in the polishing composition is preferably 10% by weight or less, more preferably 8% by weight or less, still more preferably 5% by weight or less. A smaller content of the agent having a chelating action causes excessive etching to the phase-change compound less. As a result, excessive polishing can be suppressed.

[Brittle Film Forming Agent]

The brittle film forming agent which can be contained in the polishing composition of the present invention is chemically bonded to the surface of the phase-change compound to form an insoluble brittle film. The brittle film refers to an insoluble film generated by forming a chemical bond between the phase-change compound and the brittle film forming agent, and a brittler film than the phase-change compound itself. The chemical bond referred to here is a covalent bond, an ionic bond, a hydrogen bond, a bond by an intermolecular force, or the like. A high polishing rate is obtained by mechanically polishing the brittle film with abrasive grains. Examples of the brittle film forming agent include a saturated monocarboxylic acid, a phosphoric acid compound, amine, and an ammonium compound.

Examples of the saturated monocarboxylic acid include acetic acid, lactic acid, propionic acid, butyric acid, glycolic acid, gluconic acid, salicylic acid, isonicotinic acid, isobutyric acid, valeric acid, isovaleric acid, pivalic acid, hydroangelic acid, caproic acid, 2-methyl pentanoic acid, 4-methyl-pentanoic acid, 2,3-dimethyl butanoic acid, 2-ethylbutanoic acid, 2,2-dimethyl butanoic acid, 3,3-dimethyl butanoic acid, heptanoic acid, octanoic acid, nonanoic acid, and decanoic acid. The number of carbon atoms of the saturated monocarboxylic acid is preferably 2 to 6, more preferably 2 to 4. As the saturated monocarboxylic acid having 2 to 6 carbon atoms, at least one compound selected from the group consisting of acetic acid, lactic acid, propionic acid, butyric acid, glycolic acid, gluconic acid, salicylic acid, isonicotinic acid, isobutyric acid, valeric acid, isovaleric acid, pivalic acid, hydroangelic acid, caproic acid, 2-methyl pentanoic acid, 4-methyl pentanoic acid, 2,3-dimethylbutanoic acid, 2-ethylbutanoic acid, 2,2-dimethyl butanoic acid, and 3,3-dimethyl butanoic acid, is preferable from viewpoints of easily forming an insoluble brittle film by forming a complex with the surface of the phase-change compound and obtaining a high polishing rate as a result thereof. The saturated monocarboxylic acid may be in a form of a salt. The saturated monocarboxylic acids may be each used alone, or may be used in combination of two or more kinds thereof.

Examples of the phosphoric acid compound include a compound such as phosphoric acid, phosphine, phosphine oxide, phosphine sulfide, or diphosphane; a halide thereof, a phosphonium salt, phosphonic acid, phosphinic acid, and a derivative thereof. Phosphoric acid, phosphinic acid, and phosphonic acid are preferable from viewpoints of easily forming an insoluble brittle film by forming a complex with the surface of the phase-change compound and obtaining a high polishing rate as a result thereof. More specifically, at least one kind selected from the group consisting of phosphoric acid, 2-aminoethyl phosphonic acid, 1-hydroxyethylidene-1,1-diphosphonic acid, aminotri(methylene phosphonic acid), ethylenediamine tetra(methylene phosphonic acid), diethylenetriamine penta(methylene phosphonic acid), ethane-1,1,-diphosphonic acid, ethane-1,1,2-triphosphonic acid, ethane-1-hydroxy-1,1-diphosphonic acid (HEDP), ethane-1-hydroxy-1,1,2-triphosphonic acid, ethane-1,2-dicarboxy-1,2-diphosphonic acid, methanehydroxy phosphonic acid, 2-phosphonobutane-1,2-dicarboxylic acid, 1-phosphonobutane-2,3,4-tricarboxylic acid, α-methyl phosphono succinic acid, phenyl phosphonic acid, and phosphinic acid, is preferably contained. The organic phosphorus compound may be in a form of a salt. The organic phosphorus compounds may be each used alone, or may be used in combination of two or more kinds thereof.

The amine may be an aliphatic amine or an aromatic amine. The amine may be a substituted amine or an unsubstituted amine. Among these compounds, an amine having an alkyl group, hydroxyalkyl group, or a hydroxyaryl group is preferable. Specific examples of the alkyl group include a methyl group, an ethyl group, a propyl group, an isopropyl group, an n-butyl group, an isobutyl group, a sec-butyl group, a tert-butyl group, a pentyl group, an isopentyl group, a neopentyl group, a hexyl group, a heptyl group, an octyl group, a nonyl group, a decyl group, an undecyl group, a dodecyl group, a 2-ethylhexyl group, a tetradecyl group, an octadecyl group, and an icosyl group. Specific examples of the hydroxyalkyl group and the hydroxyaryl group include methanol, ethanol, propanol, isopropanol, n-butanol, sec-butanol, tert-butanol, benzyl alcohol, and a group derived from phenol. Specific examples of the amine used include an aliphatic primary amine such as methylamine, ethylamine, propylamine, n-butylamine, sec-butylamine, tert-butylamine, or cyclohexylamine; an aliphatic secondary amine such as dimethylamine, diethylamine, dipropylamine dibutylamine, diisobutylamine, di-sec-butylamine, or di-tert-butylamine; an aliphatic tertiary amine such as trimethylamine, triethylamine, tripropylamine, or tributylamine; another chain amine such as diethylethanolamine amine, diethanolamine, or triethanolamine; and a cyclic amine such as pyridine or piperazine. Two or more kinds of amines may be used in combination.

Specific examples of the ammonium compound include a quaternary ammonium compound such as tetramethylammonium hydroxide, tetraethylammonium hydroxide, or tetrapropyl ammonium hydroxide; ammonium hydroxide (ammonia water), ammonium, and an ammonium salt. Ammonium is present in the polishing composition as an ammonium ion. An ammonium ion forms a complex with the phase-change compound especially easily. An acid component of the ammonium salt may be derived from an inorganic acid such as hydrochloric acid, nitric acid, phosphoric acid, sulfuric acid, or boric acid. Alternatively, the acid component may be derived from a fatty acid such as formic acid, acetic acid, or propionic acid; an aromatic carboxylic acid such as benzoic acid or phthalic acid; or another organic acid such as citric acid, oxalic acid, tartaric acid, malic acid, maleic acid, fumaric acid, succinic acid, an organic sulfonic acid, or an organic phosphonic acid. Two or more kinds of ammonium compounds may be used in combination.

Among these brittle film forming agents, acetic acid, lactic acid, glycolic acid, gluconic acid, propionic acid, salicylic acid, isonicotinic acid, phosphoric acid, HEDP, phosphonic acid, phosphinic acid, phenyl phosphonic acid, phosphinic acid, and ammonium hydroxide are preferable.

The lower limit of a content of the brittle film forming agent in the polishing composition is preferably 0.001% by weight or more, more preferably 0.01% by weight or more, still more preferably 0.1% by weight or more. A larger content of the brittle film forming agent makes the polishing rate higher, and therefore is preferable.

The upper limit of the content of the brittle film forming agent in the polishing composition is preferably 10% by weight or less, more preferably 8% by weight or less, still more preferably 5% by weight or less. A smaller content of the brittle film forming agent can make manufacturing cost lower, and therefore is preferable.

The agent having a chelating action and the brittle film forming agent may be each used alone, or may be used together. As is clear from the above examples of the compound, one kind of compound has both effects of the agent having a chelating action and the brittle film forming agent depending on the kind of compound.

[Oxidizing Agent]

The polishing composition according to the present invention contains an oxidizing agent. The oxidizing agent contained in the polishing composition oxidizes the surface of the phase-change compound and improves the polishing rate.

Examples of the oxidizing agent which can be used include hydrogen peroxide, peracetic acid, perbenzoic acid, tert-butyl hydroperoxide, potassium permanganate, potassium dichromate, potassium iodate, potassium periodate, nitric acid, iron nitrate, perchloric acid, hypochlorous acid, potassium ferricyanide, ammonium persulfate, and ozone water. Among these oxidizing agents, hydrogen peroxide, nitric acid, potassium periodate, hypochlorous acid, and ozone water are preferable. Hydrogen peroxide is particularly preferable. These oxidizing agents may be each used alone, or may be used in combination of two or more kinds thereof. Among these oxidizing agents, a persulfate and hydrogen peroxide are preferable. Hydrogen peroxide is particularly preferable.

The lower limit of a content of the oxidizing agent in the polishing composition is preferably 0.1% by weight or more, more preferably 0.3% by weight or more. A larger content of the oxidizing agent makes the polishing rate of the polishing object containing the phase-change compound higher.

The upper limit of the content of the oxidizing agent in the polishing composition is preferably 10% by weight or less, more preferably 5% by weight or less. A smaller content of the oxidizing agent can make cost of the polishing composition lower and can make a load of treating the polishing composition after use for polishing, that is, treating waste water, smaller. In addition, excessive oxidation of the phase-change compound is hardly caused by the oxidizing agent. Excessive polishing can be suppressed.

[Other Components]

The polishing composition of the present invention may further contain, if necessary, other components such as water, abrasive grains, a metal corrosion inhibitor, a polishing accelerator, a surfactant, an oxo acid, an antiseptic agent, antifungal agent, a reducing agent, a water-soluble polymer, or an organic solvent for dissolving a poorly soluble organic substance. Hereinafter, water, abrasive grains, a metal corrosion inhibitor, a surfactant, an antiseptic agent, and an antifungal agent which are preferable other components, will be described.

[Water]

The polishing composition of the present invention preferably contains water as a dispersion medium or a solvent for dispersing or dissolving abrasive grains. Water containing impurities as little as possible is preferable from a viewpoint of suppressing inhibition of an action of other components. Specifically, pure water, ultra-pure water, or distilled water, which is obtained by removing impurity ions using an ion exchange resin and then removing foreign matters through a filter, is preferable.

[Abrasive Grains]

The polishing composition of the present invention may contain abrasive grains. The abrasive grains may be any of inorganic particles, organic particles, and organic-inorganic composite particles. Specific examples of the inorganic particles include particles made of a metal oxide such as silica, alumina, ceria, or titania, silicon nitride particles, silicon carbide particles, and boron nitride particles. Specific examples of the organic particles include methyl polymethacrylate (PMMA) particles. Among these abrasive grains, the silica particles are preferable, and colloidal silica is particularly preferable.

The abrasive grains may be surface-modified. Usually, a zeta potential value of the colloidal silica is nearly zero under acidic conditions. Therefore, silica particles are easily agglomerated without electrically repelling each other under acidic conditions. Meanwhile, abrasive grains which are surface-modified so as to have a relatively large positive or negative value of zeta potential even in acidic conditions, strongly repel each other and are well dispersed even under acidic conditions. As a result, storage stability of the polishing composition is improved. Such surface-modified abrasive grains can be obtained by mixing a metal such as aluminum, titanium, or zirconium, or an oxide thereof with abrasive grains to be doped in a surface of the abrasive surface, for example.

Alternatively, the surface-modified abrasive grains in the polishing composition may be silica with an immobilized organic acid. Particularly, colloidal silica with an immobilized organic acid can be preferably used. An organic acid is immobilized to colloidal silica by chemically bonding a functional group of the organic acid to a surface of the colloidal silica. An organic acid is not immobilized to colloidal silica only by coexist of the colloidal silica and the organic acid. Sulfonic acid which is a kind of organic acid can be immobilized to colloidal silica, for example, by a method described in “Sulfonic acid-functionalized silica through quantitative oxidation of thiol groups”, Chem. Commun. 246-247 (2003). Specifically, by coupling a silane coupling agent having a thiol group, such as 3-mercaptopropyl trimethoxysilane to colloidal silica and then oxidizing the thiol group by hydrogen peroxide, it is possible to obtain colloidal silica with the surface of which sulfonic acid has been immobilized. Alternatively, carboxylic acid can be immobilized to colloidal silica, for example, by a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, by coupling a silane coupling agent containing a photoreactive 2-nitrobenzyl ester to colloidal silica and then irradiating the resulting colloidal silica with light, it is possible to obtain colloidal silica with the surface of which carboxylic acid has been immobilized.

A content of the abrasive grains in the polishing composition is preferably 0.1% by weight or more, more preferably 0.5% by weight or more, still more preferably 1% by weight or more. A larger content of the abrasive grains advantageously makes a rate of removing a polishing object by the polishing composition higher.

The content of the abrasive grains in the polishing composition is preferably 20% by weight or less, more preferably 15% by weight or less, still more preferably 10% by weight or less. A smaller content of the abrasive grains can make material cost of the polishing composition lower.

The average primary particle diameter of the abrasive grains is preferably 5 nm or more, more preferably 7 nm or more, still more preferably 10 nm or more. A larger average primary particle diameter of the abrasive grains advantageously makes the rate of removing a polishing object by the polishing composition higher. A value of the average primary particle diameter of the abrasive grains can be calculated, for example, based on a specific surface area of the abrasive grains measured by a BET method.

The average primary particle diameter of the abrasive grains is preferably 100 nm or less, more preferably 90 nm or less, still more preferably 80 nm or less. A smaller average primary particle diameter of the abrasive grains makes it possible to easily obtain a polished surface with less surface defect by polishing a polishing object using the polishing composition.

The average secondary particle diameter of the abrasive grains is preferably 150 nm or less, more preferably 120 nm or less, still more preferably 100 nm or less. A value of the average secondary particle diameter of the abrasive grains can be measured, for example, by a laser light scattering method.

The average association degree of the abrasive grains is preferably 1.2 or more, more preferably 1.5 or more. The average association degree is obtained by dividing a value of the average secondary particle diameter of the abrasive grains by a value of the average primary particle diameter. A larger average association degree of the abrasive grains advantageously makes the rate of removing a polishing object by the polishing composition higher.

The average association degree of the abrasive grains is preferably 4 or less, more preferably 3 or less, still more preferably 2 or less. A smaller average association degree of the abrasive grains makes it possible to easily obtain a polished surface with less surface defect.

[Metal Corrosion Inhibitor]

The polishing composition of the present invention can contain a metal corrosion inhibitor. By adding a metal corrosion inhibitor into the polishing composition, a surface defect such as dishing is less likely to occur in a phase-change compound after the phase-change compound is polished using the polishing composition. In addition, the metal corrosion inhibitor alleviates oxidation of the surface of the phase-change compound by an oxidizing agent, and generates an insoluble complex by reacting with a metal ion generated by oxidation of metal on the surface of the phase-change compound by the oxidizing agent. As a result, it is possible to suppress etching of the phase-change compound by an agent having a chelating action, and suppress excessive polishing.

The metal corrosion inhibitor which can be used is not particularly limited. However, a preferable example thereof is a compound in which two carbonyl groups contained in a molecule are bonded to carbon atoms in 1-position and 3-position of the molecule. Examples thereof include a β-diketone compound represented by general formula (1) below, a β-ketoamide compound represented by general formula (2) below, and a β-ketoester compound represented by general formula (3) below.

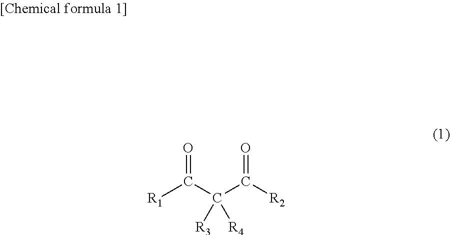

In general formula (1), R₁, R₂, R₃, and R₄ are each independently a hydrogen atom, an alkyl group having one to four carbon atoms, a hydroxyethyl group, or an optionally substituted aryl group. In this case, R₁ and R₃, and R₂ and R₄ may be bonded to each other to form a five-membered ring or a six-membered ring.

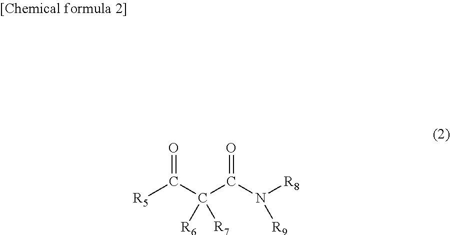

In general formula (2), R₅, R₆, R₇, R₈, and R₉ are each independently a hydrogen atom, an alkyl group having one to four carbon atoms, a hydroxyethyl group, or an optionally substituted aryl group. In this case, R₅ and R₆, R₆ and R₇, R₇ and R₉, and R₈ and R₉ may be bonded to each other to form a five-membered ring or a six-membered ring.

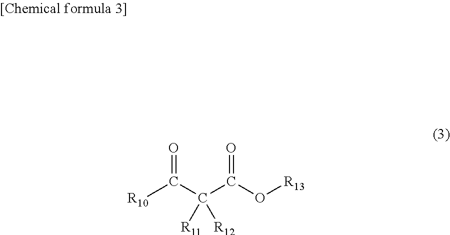

In general formula (3), R₁₀, R₁₁, R₁₂, and R₁₃ are each independently a hydrogen atom, an alkyl group having one to four carbon atoms, a hydroxyethyl group, or an optionally substituted aryl group. In this case, R₁₀ and R₁₁, R₁₁ and R₁₂, and R₁₂ and R₁₃ may be bonded to each other to form a five-membered ring or a six-membered ring.

When the compound in which two carbonyl groups contained in a molecule contained in the polishing composition are bonded to carbon atoms in 1-position and 3-position of the molecule is a β-diketone compound represented by general formula (1) above, specific examples thereof include acetylacetone, trifluoroacetylacetone, propionyl acetone, benzoyl acetone, benzoyl trifluoroacetone, and dibenzoylmethane. One kind of these compounds may be used alone or a combination of two or more kinds thereof may be used.

When the compound in which two carbonyl groups contained in a molecule contained in the polishing composition are bonded to carbon atoms in 1-position and 3-position of the molecule is a β-ketoamide compound represented by general formula (2) above, specific examples thereof include N-methylacetoacetic acid amide, N,N-dimethylacetoacetic acid amide, N-(2-hydroxyethyl)acetoacetic acid amide, acetoacetic acid anilide, N-(2-methylphenyl)acetoacetic acid amide N-(4-methoxyphenyl)acetoacetic acid amide, N-(4-chlorophenyl)acetoacetic acid amide, and 3-oxopentanoic acid amide. One kind of these compounds may be used alone or a combination of two or more kinds thereof may be used.

When the compound in which two carbonyl groups contained in a molecule contained in the polishing composition are bonded to carbon atoms in 1-position and 3-position of the molecule is a β-ketoester compound represented by general formula (3) above, specific examples thereof include methyl acetoacetate, ethyl acetoacetate, octyl acetoacetate, oleyl acetoaceta lauryl acetoacetate, stearyl acetoacetate, benzyl acetoacetate, methyl 3-oxopentanoate, and octyl 3-oxopentanoate. One kind of these compounds may be used alone or a combination of two or more kinds thereof may be used.

The upper limit of a content of the compound in which two carbonyl groups contained in a molecule in the polishing composition are bonded to carbon atoms in 1-position and 3-position is preferably 10% by weight or less, more preferably 8% by weight or less, still more preferably 5% by weight or less. A smaller content of the compound in which two carbonyl groups contained in a molecule are bonded to carbon atoms in 1-position and 3-position makes the polishing rate higher, and is preferable.

The lower limit of the content of the compound in which two carbonyl groups contained in a molecule in the polishing composition are bonded to carbon atoms in 1-position and 3-position is preferably 0.0001% by weight or more, more preferably 0.001% by weight or more, still more preferably 0.01% by weight or more. A larger content of the compound in which two carbonyl groups contained in a molecule are bonded to carbon atoms in 1-position and 3-position further suppresses etching. As a result, it is possible to suppress generation of recess. Therefore, the larger content is preferable.

Other examples of the metal corrosion inhibitor include a heterocyclic compound. Specific examples of the heterocyclic compound which can be used include anitrogen-containing heterocyclic compound such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolizine compound, a quinoline compound, an isoquinoline compound, a naphthyridine compound, a phthalazine compound, a quinoxaline compound, a quinazoline compound, a cinnoline compound, a pteridin compound, a thiazole compound, an isothiazole compound, an oxazole compound, an isoxazole compound, or a furazan compound.

More specifically, examples of the pyrazole compound include 1H-pyrazole, 4-nitro-3-pyrazole carboxylic acid, 3,5-pyrazole carboxylic acid, 3-amino-5-phenylpyrazole, 5-amino-3-phenyl pyrazole, 3,4,5-tribromopyrazole, 3-aminopyrazole, 3,5-dimethylpyrazole, 3,5-dimethyl-1-hydroxymethylpyrazole, 3-methylpyrazole, 1-methylpyrazole, 3-amino-5-methylpyrazole, 4-amino-pyrazolo[3,4-d]pyrimidine, allopurinol, 4-chloro-1H-pyrazolo[3,4-D]pyrimidine, 3,4-dihydroxy-6-methylpyrazolo (3,4-B)-pyridine, and 6-methyl-1H-pyrazolo[3,4-b]pyridin-3-amine.

Examples of the imidazole compound include imidazole, 1-methyl imidazole, 2-methylimidazole, 4-methylimidazole, 1,2-dimethylpyrazole, 2-ethyl-4-methylimidazole, 2-isopropylimidazole, benzimidazole, 5,6-dimethyl benzimidazole, 2-amino benzimidazole, 2-chloro benzimidazole, 2-methyl benzimidazole, 2-(1-hydroxyethyl)benzimidazole, 2-hydroxy benzimidazole, 2-phenyl benzimidazole, 2,5-dimethyl benzimidazole, 5-methyl benzimidazole, 5-nitro benzimidazole, and 1H-purine.

Examples of the triazole compound include 1,2,3-triazole (1H-BTA), 1,2,4-triazole, 1-methyl-1,2,4-triazole, methyl-1H-1,2,4-triazole-3-carboxylate, 1,2,4-triazole-3-carboxylic acid, 1,2,4-triazole-3-methyl carboxylate, 1H-1,2,4-triazole-3-thiol, 3,5-diamino-1H-1,2,4-triazole, 3-amino-1,2,4-triazole-5-thiol, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazole-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-diheptyl-4H-1,2,4-triazole, 5-methyl-1,2,4-triazole-3,4-diamine, 1H-benzotriazole, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5-methyl-1H-benzotriazole, 5,6-dimethyl-1H-benzotriazole, 1-(1′,2′-dicarboxyethyl)benzotriazole, 1-[N,N-bis(hydroxyethyl)aminomethyl]benzotriazole, 1-[N,N-bis(hydroxyethyl)aminomethyl]-5-methylbenzotriazole, and 1 [N,N-bis(hydroxyethyl)aminomethyl]-4-methylbenzotriazole.

Examples of the tetrazole compound include 1H-tetrazole, 5-methyltetrazole, 5-aminotetrazole, and 5-phenyltetrazole.

Examples of the indazole compound include 1H-indazole, 5-amino-1H-indazole, 5-nitro-1H-indazole, 5-hydroxy-1H-indazole, 6-amino-1H-indazole, 6-nitro-1H-indazole, 6-hydroxy-1H-indazole, and 3-carboxy-5-methyl-1H-indazole.

Examples of the indole compound include 1H-indole, 1-methyl-1H-indole, 2-methyl-1H-indole, 3-methyl-1H-indole, 4-methyl-1H-indole, 5-methyl-1H-indole, 6-methyl-1H-indole, 7-methyl-1H-indole, 4-amino-1H-indole, 5-amino-1H-indole, 6-amino-1H-indole, 7-amino-1H-indole, 4-hydroxy-1H-indole, 5-hydroxy-1H-indole, 6-hydroxy-1H-indole, 7-hydroxy-1H-indole, 4-methoxy-1H-indole, 5-methoxy-1H-indole, 6-methoxy-1H-indole, 7-methoxy-1H-indole, 4-chloro-1H-indole, 5-chloro-1H-indole, 6-chloro-1H-indole, 7-chloro-1H-indole, 4-carboxy-1H-indole, 5-carboxy-1H-indole, 6-carboxy-1H-indole, 7-carboxy-1H-indole, 4-nitro-1H-indole, 5-nitro-1H-indole, 6-nitro-1H-indole, 7-nitro-1H-indole, 4-nitrile-1H-indole, 5-nitrile-1H-indole, 6-nitrile-1H-indole, 7-nitrile-1H-indole, 2,5-dimethyl-1H-indole, 1,2-dimethyl-1H-indole, 1,3-dimethyl-1H-indole, 2,3-dimethyl-1H-indole, 5-amino-2,3-dimethyl-1H-indole, 7-ethyl-1H-indole, 5-(aminomethyl)indole, 2-methyl-5-amino-1H-indole, 3-hydroxymethyl-1H-indole, 6-isopropyl-1H-indole, and 5-chloro-2-methyl-1H-indole.

Among these heterocyclic compounds, a preferable heterocyclic compound is a triazole compound. Particularly, 1H-benzotriazole, 5-methyl-1H-benzotriazole, 5,6-dimethyl-1H-benzotriazole, 1-[N,N-bis(hydroxyethyl)aminomethyl]-5-methyl benzotriazole, 1 [N,N-bis(hydroxyethyl)aminomethyl]-4-methylbenzotriazole, 1,2,3-triazole, and 1,2,4-triazole are preferable. These heterocyclic compounds have a high chemical or physical adsorption force to the surface of the phase-change compound, and therefore can form a stronger protective film on the surface of the phase-change compound. This is advantageous in improving flatness of the surface of the phase-change compound after the surface of the phase-change compound is polished using the polishing composition of the present invention.

Among these metal corrosion inhibitors, a preferable metal corrosion inhibitor is a nitrogen-containing five-membered ring compound. At least one kind selected from the group consisting of 1H-pyrazole, 1,2,4-triazole, and 1H-tetrazole is more preferable. It is possible to suppress excessive etching of the phase-change compound by using these compounds.

The lower limit of a content of the metal corrosion inhibitor in the polishing composition is preferably 0.001 g/L or more, more preferably 0.005 g/L or more, still more preferably 0.01 g/L or more. The upper limit of the content of the metal corrosion inhibitor in the polishing composition is preferably 10 g/L or less, more preferably 5 g/L or less, still more preferably 2 g/L or less. Within these ranges, flatness of the surface of the phase-change compound after the surface of the phase-change compound is polished using the polishing composition is improved, and the polishing rate by the polishing composition is improved.

[Surfactant]

The polishing composition according to the present invention can contain a surfactant. By adding a surfactant into the polishing composition, it is possible to further suppress dishing of the phase-change compound after the phase-change compound is polished.

The surfactant used may be any one of an anionic surfactant, a cationic surfactant, an amphoteric surfactant, and a nonionic surfactant. However, particularly, an anionic surfactant and a nonionic surfactant are preferable. A plurality of kinds of surfactants may be used in combination. Particularly, use of combination of an anionic surfactant and a nonionic surfactant is preferable.

Specific examples of the anionic surfactant include polyoxyethylene alkyl ether acetic acid, polyoxyethylene alkyl ether sulfuric acid, alkyl ether sulfuric acid, polyoxyethylene alkyl sulfate ester, alkyl sulfate ester, polyoxyethylene alkyl sulfuric acid, alkyl sulfuric acid, alkyl benzene sulfonic acid, alkyl phosphate ester, polyoxyethylene alkyl phosphate ester, polyoxyethylene sulfosuccinic acid, alkyl sulfosuccinic acid, alkyl naphthalene sulfonic acid, alkyl diphenyl ether disulfonic acid, and salts thereof. Among these anionic surfactants, polyoxyethylene alkyl ether acetic acid, polyoxyethylene alkyl ether sulfate salt, alkyl ether sulfate salt, and alkyl benzene sulfate salt are preferable. These preferable anionic surfactants have a high chemical or physical adsorption force to the surface of the phase-change compound, and therefore forma stronger protective film on the surface of the phase-change compound. This is advantageous in improving flatness of the surface of the phase-change compound after the surface of the phase-change compound is polished using the polishing composition.

Specific examples of the cationic surfactant include an alkyl trimethyl ammonium salt, an alkyl dimethyl ammonium salt, an alkyl benzyl dimethyl ammonium salt, and an alkylamine salt.

Specific examples of the amphoteric surfactant include alkyl betaine and alkyl amine oxide.

Specific examples of the nonionic surfactant include polyoxyalkylene alkyl ether such as polyoxyethylene alkyl ether, a sorbitan fatty acid ester, a glycerin fatty acid ester, a polyoxyethylene fatty acid ester, polyoxyethylene alkylamine, and alkyl alkanol amide. Among these nonionic surfactants, polyoxyalkylene alkyl ether is preferable. Polyoxyalkylene alkyl ether has a high chemical or physical adsorption force to the surface of the phase-change compound, and therefore forms a stronger protective film on the surface of the phase-change compound. This is advantageous in improving flatness of the surface of the phase-change compound after the surface of the phase-change compound is polished using the polishing composition.

A content of the surfactant in the polishing composition is preferably 0.001 g/L or more, more preferably 0.005 g/L or more, still more preferably 0.01 g/L or more. A larger content of the surfactant advantageously makes the surface of the phase-change compound after the surface of the phase-change compound is polished using the polishing composition flatter. The content of the surfactant in the polishing composition is preferably 10 g/L or less, more preferably 5 g/L or less, still more preferably 1 g/L or less. A smaller content of the surfactant advantageously makes the polishing rate by the polishing composition higher.

[Oxo Acid]

The polishing composition according to the present invention can contain an oxo acid.

The “oxo acid” is also referred to as an oxy acid or an oxygen acid, is an acid in which a hydrogen atom which can be dissociated as a proton (H⁺) is bonded to an oxygen atom, and is represented by a general formula XOₙ(OH)ₘ. Examples of a typical oxo acid include sulfuric acid (H₂SO₄), nitric acid (HNO₃) and phosphoric acid (H₃PO₄) which are inorganic acids containing no metal element or semimetal atom. However, the polishing composition according to the present embodiment is characterized by containing an oxo acid “containing a metal element or a semimetal element”.

Here, the “metal element” refers to an element having a metallic property that a simple substance thereof “has a metallic luster, excellent malleability and ductility, and remarkable conductivity of electricity and heat”. All the elements conventionally known as a “metal element” are included in this concept. The “semimetal element” is also referred to as a metalloid, and is an element exhibiting an intermediate property between a metal and a non-metal. A strictly unique definition does not exist for the semimetal element. However, here, boron (B), silicon (Si), germanium (Ge), arsenic (As), selenium (Se), antimony (Sb), tellurium (Te), polonium (Po), and astatine (At) are referred to.

In a preferable embodiment, the metal element or the semimetal element contained in the oxo acid is preferably an element belonging to groups 3 to 17 in the long-period periodic table of elements, more preferably B, Al, Si, Sc, Ti, V, Cr, Mn, Fe, Co, Ni, Cu, Zn, Ga, Ge, As, Se, Y, Zr, Nb, Mo, Ru, Rh, Pd, Ag, Cd, In, Sn, Sb, Te, La, Ce, Pr, Nd, Sm, Eu, Gd, Tb, Dy, Ho, Er, Tm, Yb, Lu, Hf, Ta, W, Re, Os, Ir, Tl, Pb, Bi, Po, At, Ac, Th, Pa, U, Np, or Pu. A particularly preferable metal element contained in the oxo acid is tungsten (W), molybdenum (Mo), vanadium (V), manganese (Mn), copper (Cu), iron (Fe), aluminum (Al), cobalt (Co), tantalum (Ta), tin (Sn), gallium (Ga), indium (In), zinc (Zn), lead (Pb), or niobium (Nb). A most preferable metal element is tungsten (W) or molybdenum (Mo). A particularly preferable semimetal element contained in the oxo acid is tellurium (Te), germanium (Ge), antimony (Sb), or silicon (Si). A most preferable semimetal element is tellurium (Te).

Specific examples of the oxo acid containing a metal element or a semimetal element are not particularly limited, and include an oxo acid containing the above-described metal element or semimetal element. More specific examples thereof include telluric acid (Te(OH)₆), tungstic acid (H₂WO₄(WO₃.H₂O), H₄WO₅ (WO₃.2H₂O)), molybdic acid (MoO₃.H₂O), silicotungstic acid (H₄[SiW₁₂O₄₀]), phosphotungstic acid (H₃[PW₁₂O₄₀]), metavanadic acid (HVO₃), permanganic acid, aluminic acid, stannic acid, germanic acid, and silicic acid. Various polyacids in which a central atom or a metal atom of a polyacid such as the above-described silicotungstic acid or phosphotungstic acid is replaced with another atom may be used as the oxo acid in this embodiment. Two or more kinds of oxo acids may be used in combination.

Here, a concept of the “oxo acid” also includes a form of a salt or a hydrate thereof. The salt of the oxo acid is a salt of a suitable cation and an anion in which a proton (H⁺) has been released from the above-described oxo acid. Examples of the cation forming the salt of the oxo acid include an alkali metal such as sodium or potassium, an alkaline earth metal such as calcium, an ammonium ion (NH₄⁺), a primary amine, a secondary amine, a tertiary amine, and a quaternary amine. The number of water molecules hydrated with the oxo acid in a hydrate of the oxo acid is not particularly limited. Conventionally known knowledge can be appropriately referred to. When the polishing composition contains a solvent such as water, the oxo acid (salt) is usually present in a form of an ion, such as anion. Even this case is not different in that “the polishing composition contains an oxo acid”.

The lower limit of a content of the oxo acid in the polishing composition according to the present embodiment is not particularly limited because only a small amount thereof exhibits an effect. However, the content is preferably 0.0001% by weight or more, more preferably 0.0005% by weight or more, particularly preferably. 001% by weight or more with respect to 100% by weight of the total amount of the composition. The upper limit of the content of the oxo acid in the polishing composition according to the present embodiment is not particularly limited, either. However, the content is preferably 15% by weight or less, more preferably 10% by weight or less, particularly preferably 5% by weight or less with respect to 100% by weight of the total amount of the composition from viewpoints of unit manufacturing cost and a residual property to a polishing object depending on solubility.

[Antiseptic Agent and Antifungal Agent]

Examples of an antiseptic agent and antifungal agent used in the present invention include an isothiazoline-based antiseptic agent such as 2-methyl-4-isothiazolin-3-one or 5-chloro-2-methyl-4-isothiazolin-3-one, a paraoxybenzoic acid ester, and phenoxyethanol. These antiseptic agents and antifungal agents may be each used alone, or may be used in combination of two or more kinds thereof.

[pH of Polishing Composition]

The lower limit of pH of the polishing composition of the present invention is not particularly limited, but is preferably 1 or more, more preferably 2 or more. A larger value of pH of the polishing composition makes a handling property better.

The upper limit of pH of the polishing composition is not particularly limited, but is preferably 12 or less, more preferably 11 or less. A smaller value of pH of the polishing composition can further prevent dissolution of abrasive grains.

In order to adjust pH of the polishing composition to a desired value, a pH adjusting agent may be used. The pH adjusting agent used may be an acid or an alkali, and an inorganic or organic compound. The pH adjusting agents may be each used alone, or may be used in combination of two or more kinds thereof. When an additive having a pH adjusting function (for example, various acids) is used as the above-described various additives, the additive may be used as at least a part of the pH adjusting agent.

[Method for Manufacturing Polishing Composition]

A method for manufacturing the polishing composition of the present invention is not particularly limited. For example, by stirring and mixing an organic compound, an agent having a chelating action, a brittle film forming agent, an oxidizing agent, and if necessary other components in water, it is possible to obtain the polishing composition.

Temperature during mixing each component is not particularly limited, but is preferably 10 to 40° C. The components may be heated in order to increase a dissolution rate. Mixing time is not particularly limited, either.

[Polishing Method and Method for Manufacturing Substrate]

As described above, the polishing composition of the present invention is suitably used for polishing a polishing object containing the above-described phase-change compound. Therefore, the present invention provides a method for polishing a polishing object containing a phase-change compound using the polishing composition of the present invention. In addition, the present invention provides a method for manufacturing a substrate, including a step of polishing a polishing object containing a phase-change compound by the above-described polishing method.

As a polishing apparatus, it is possible to use a general polishing apparatus provided with a holder to hold a substrate or the like, a motor the rotation number of which can be changed, and the like, and having a polishing surface plate to which a polishing pad (polishing cloth) can be pasted.

As the polishing pad, general nonwoven fabric, polyurethane, a porous fluororesin, or the like can be used without particular limitation. Groove machining has been preferably applied to the polishing pad so as to store a polishing liquid.

However, the lower limit of Shore D hardness of the polishing pad for polishing a polishing object containing a phase-change compound is preferably 50 or more, more preferably 60 or more. Higher Shore D hardness of the polishing pad makes a mechanical function of the polishing pad larger and makes the polishing rate higher. The polishing composition of the present invention has an advantage that a high polishing rate can be obtained without containing abrasive grains.

The upper limit of Shore D hardness of the polishing pad for polishing the polishing object containing the phase-change compound is preferably 99 or less. Lower Shore D hardness of the polishing pad makes the polishing object less scratched. The upper limit of shore D hardness of the polishing pad is more preferably 95 or less from such a viewpoint. The Shore D hardness is not 100 or more by definition. The Shore D hardness of the polishing pad can be measured by a Shore D hardness meter.

A polishing pad having Shore D hardness of 50 or more may be a foamed body or a non-foamed body such as cloth or nonwoven fabric. Examples of a material of the polishing pad which can be used include a resin such as polyurethane, acrylic, polyester, an acrylic-ester copolymer, polytetrafluoroethylene, polypropylene, polyethylene, poly 4-methylpentene, cellulose, a cellulose ester, polyamide such as nylon or aramid, polyimide, polyimide amide, a polysiloxane copolymer, an oxirane compound, phenolic resin, polystyrene, polycarbonate, or an epoxy resin.

Polishing conditions are not particularly limited. For example, a rotational speed of a polishing surface plate is preferably 10 to 500 rpm, and a pressure (polishing pressure) applied to a polishing object containing a phase-change compound is preferably 0.5 to 10 psi. A method for supplying a polishing composition to a polishing pad is not particularly limited. For example, a method of continuously supplying the polishing composition using a pump or the like is used. A supply amount of the polishing composition is not limited. However, the surface of the polishing pad is preferably covered with the polishing composition of the present invention all the time.

After polishing is finished, the polishing object is washed with running water, and water droplets adhering onto the polishing object are shaken off and dried using a spin dryer or the like to thereby obtain a substrate containing a phase-change compound.

The polishing composition of the present invention may be a one-liquid type or a multi-liquid type including a two-liquid type. The polishing composition of the present invention may be prepared by diluting a stock solution of the polishing composition with a diluent such as water, for example, 10 times or more.

### Examples

Next, Examples and Comparative Examples of the present invention will be described.

Polishing compositions of Examples 1 to 18 and Comparative Examples 1 to 44 were prepared by mixing components in water so as to have compositions described in Tables 2 to 8 below. Tables 2 to 8 below indicate the kind and an addition amount for each of an organic compound, and an agent having a chelating action or a brittle film forming agent, contained in each polishing composition. The notation “-” indicates not containing a corresponding additive. The column “pH” in Tables 2 to 8 below indicates pH of each polishing composition. Although not indicated in Tables 2 to 8 below, colloidal silica having an average secondary particle diameter of about 60 nm (average primary particle diameter of 30 nm) was used as abrasive grains, and was added so as to be 2.5% by weight with respect to the total weight of the composition. The pH was adjusted to a predetermined value using nitric acid and/or potassium hydroxide. Although not indicated in Tables 2 to 8 below, hydrogen peroxide was added as an oxidizing agent to each polishing composition so as to be 2.1% by weight with respect to the total weight of the composition. However, hydrogen peroxide was not added in Comparative Examples 2 and 11.

A blanket wafer including a GST alloy (weight ratio among Ge, Sb, and Te is 2:2:5), a blanket wafer including TEOS, and a blanket wafer including SiN were polished using each polishing composition of Examples 1 to 18 and Comparative Examples 1 to 44 under conditions indicated in Table 1 below.

When polishing was performed for fixed time under the conditions in Table 1 below, a polishing rate of the GST alloy was determined by dividing a difference in thickness of blanket wafer between before and after polishing, determined from fluorescen X-ray spectroscopy (XRF), by polishing time. A polishing rate of TEOS or SiN was determined by dividing a difference in thickness of blanket wafer between before and after polishing, determined using an optical interference type film thickness measuring device, by polishing time. Results thereof are indicated in the column “polishing rate” in Tables 2 to 8 below. A value obtained by dividing the polishing rate of the GST alloy by the polishing rate of TEOS is indicated in the column “GST/TEOS rate ratio”. A value obtained by dividing the polishing rate of the GST alloy by the polishing rate of SiN is indicated in the column “GST/SiN rate ratio”.

TABLE 1

polishing machine: one-side CMP polishing device
polishing pad: polishing pad made of polyurethane
polishing pressure: 1.2 psi (≈85 hPa)
rotation number of surface plate: 60 rpm
polishing composition: poured and flowed
rotation number of carrier: 60 rpm

TABLE 2

| | organic compound | | | brittle film forming agent | | | | | | | | |
|---|---|---|---|---|---|---|---|---|---|---|---|---|
| | | content | concen- | | content | concen- | | GST | TEOS | GST/ | SiN | GST/ |
| | | (% by | tration | | % by | tration | | polishing | polishing | TEOS | polishing | SiN |
| | kind | weight) | (mol/L) | kind | weight) | (mol/L) | pH | rate (Å/min) | rate (Å/min) | rate ratio | rate (Å/min) | rate ratio |
| Example 1 | trehalose | 3.4 | 0.1 | ammonium | 0.5 | 0.14 | 3 | 161 | 148 | 1.1 | 48 | 3.4 |
| | | | | hydroxide | | | | | | | | |
| Example 2 | trehalose | 3.4 | 0.1 | ammonium | 1.0 | 0.28 | 3 | 201 | 174 | 1.2 | 55 | 3.7 |
| | | | | hydroxide | | | | | | | | |
| Example 3 | trehalose | 3.4 | 0.1 | ammonium | 2.0 | 0.56 | 3 | 242 | 201 | 1.2 | 63 | 3.8 |
| | | | | hydroxide | | | | | | | | |
| Comparative | — | — | — | — | — | — | 3 | 15 | 121 | 0.1 | 48 | 0.3 |
| Example 1 | | | | | | | | | | | | |
| Comparative | — | — | — | ammonium | 0.5 | 0.14 | 3 | 24 | 143 | 0.2 | 51 | 0.5 |
| Example 2 | | | | hydroxide | | | | | | | | |
| Comparative | — | — | — | ammonium | 0.5 | 0.14 | 3 | 95 | 148 | 0.6 | 48 | 2.0 |
| Example 3 | | | | hydroxide | | | | | | | | |
| Comparative | — | — | — | ammonium | 1.0 | 0.28 | 3 | 114 | 174 | 0.7 | 55 | 2.1 |
| Example 4 | | | | hydroxide | | | | | | | | |
| Comparative | — | — | — | ammonium | 2.0 | 0.56 | 3 | 111 | 201 | 0.6 | 63 | 1.8 |
| Example 5 | | | | hydroxide | | | | | | | | |
| Comparative | methanol | 0.32 | 0.14 | — | — | — | 3 | 20 | 122 | 0.2 | 51 | 0.4 |
| Example 6 | | | | | | | | | | | | |
| Comparative | polyethylene | 0.46 | 0.14 | — | — | — | 3 | 17 | 123 | 0.1 | 49 | 0.3 |
| Example 7 | glycol (PEG) | | | | | | | | | | | |
| Comparative | trehalose | 3.4 | 0.1 | — | — | — | 3 | 58 | 124 | 0.5 | 50 | 1.2 |
| Example 8 | | | | | | | | | | | | |
| Comparative | methanol | 0.32 | 0.14 | ammonium | 0.5 | 0.14 | 3 | 91 | 145 | 0.6 | 52 | 1.8 |
| Example 9 | | | | hydroxide | | | | | | | | |
| Example 4 | trehalose | 3.4 | 0.1 | ammonium | 0.5 | 0.14 | 10 | 173 | 52 | 3.3 | 37 | 4.7 |
| | | | | hydroxide | | | | | | | | |
| Example 5 | trehalose | 3.4 | 0.1 | ammonium | 1.0 | 0.28 | 10 | 216 | 121 | 1.8 | 41 | 5.3 |
| | | | | hydroxide | | | | | | | | |
| Example 6 | trehalose | 3.4 | 0.1 | ammonium | 2.0 | 0.56 | 10 | 260 | 148 | 1.8 | 47 | 5.5 |
| | | | | hydroxide | | | | | | | | |
| Comparative | — | — | — | — | — | — | 10 | 17 | 38 | 0.4 | 37 | 0.5 |
| Example 10 | | | | | | | | | | | | |
| Comparative | — | — | — | ammonium | | | 10 | 26 | 56 | 0.5 | 36 | 0.7 |
| Example 11 | | | | hydroxide | | | | | | | | |
| Comparative | — | — | — | ammonium | | | 10 | 104 | 52 | 2.0 | 37 | 2.8 |
| Example 12 | | | | hydroxide | | | | | | | | |
| Comparative | — | — | — | ammonium | | | 10 | 125 | 121 | 1.0 | 41 | 3.0 |
| Example 13 | | | | hydroxide | | | | | | | | |
| Comparative | — | — | — | ammonium | | | 10 | 137 | 148 | 0.9 | 47 | 2.9 |
| Example 14 | | | | hydroxide | | | | | | | | |
| Comparative | methanol | 0.32 | 0.14 | — | — | — | 10 | 32 | 40 | 0.8 | 36 | 0.9 |
| Example 15 | | | | | | | | | | | | |
| Comparative | polyethylene | 0.46 | 0.14 | — | — | — | 10 | 28 | 42 | 0.7 | 38 | 0.7 |
| Example 16 | glycol (PEG) | | | | | | | | | | | |
| Comparative | trehalose | 3.4 | 0.1 | — | — | — | 10 | 82 | 42 | 2.0 | 36 | 2.3 |
| Example 17 | | | | | | | | | | | | |
| Comparative | methanol | 0.32 | 0.14 | ammonium | 0.5 | 0.14 | 10 | 102 | 51 | 2.0 | 38 | 2.7 |
| Example 18 | | | | hydroxide | | | | | | | | |

TABLE 3

| | | | | agent having a | | | | | | | | |
|---|---|---|---|---|---|---|---|---|---|---|---|---|
| | organic compound | | | chelating action | | | | | | | | |
| | | content | concen- | | content | concen- | | GST | TEOS | GST/ | SiN | GST/ |
| | | (% by | tration | | (% by | tration | | polishing | polishing | TEOS | polishing | SiN |
| | kind | weight) | (mol/L) | kind | weight) | (mol/L) | pH | rate (Å/min) | rate (Å/min) | rate ratio | rate (Å/min) | rate ratio |
| Example 7 | fructose | 1.8 | 0.1 | citric acid | 2.69 | 0.14 | 3 | 148 | 126 | 1.2 | 53 | 2.8 |
| Comparative | fructose | 1.8 | 0.1 | — | — | — | 3 | 64 | 122 | 0.5 | 49 | 1.3 |
| Example 19 | | | | | | | | | | | | |
| Comparative | — | — | — | citric acid | 2.69 | 0.14 | 3 | 89 | 128 | 0.7 | 53 | 1.7 |
| Example 20 | | | | | | | | | | | | |
| Comparative | polyethylene | 0.46 | 0.14 | citric acid | 2.69 | 0.14 | 3 | 91 | 128 | 0.7 | 53 | 1.7 |
| Example 21 | glycol (PEG) | | | | | | | | | | | |
| Example 8 | fructose | 1.8 | 0.1 | citric acid | 2.69 | 0.14 | 10 | 186 | 155 | 1.2 | 142 | 1.3 |
| Comparative | fructose | 1.8 | 0.1 | — | — | — | 10 | 76 | 38 | 2.0 | 37 | 2.1 |
| Example 22 | | | | | | | | | | | | |
| Comparative | — | — | — | citric acid | 2.69 | 0.14 | 10 | 156 | 165 | 0.9 | 142 | 1.1 |
| Example 23 | | | | | | | | | | | | |
| Comparative | polyethylene | — | 0.14 | citric acid | 2.69 | 0.14 | 10 | 134 | 165 | 0.8 | 142 | 0.9 |
| Example 24 | glycol (PEG) | | | | | | | | | | | |

TABLE 4

| | organic compound | | | brittle film forming agent | | | | GST | TEOS | | SiN | |
|---|---|---|---|---|---|---|---|---|---|---|---|---|
| | | | concen- | | | concen- | | polishing | polishing | GST/ | polishing | GST/ |
| | | content (% | tration | | content (% | tration | | rate | rate | TEOS | rate | SiN |
| | kind | by weight) | (mol/L) | kind | by weight) | (mol/L) | pH | (Å/min) | (Å/min) | rate ratio | (Å/min) | rate ratio |
| Example 9 | sorbitol | 1.8 | 0.1 | HEDP | 2.88 | 0.14 | 3 | 253 | 152 | 1.7 | 83 | 3.0 |
| Comparative | sorbitol | 1.8 | 0.1 | — | — | — | 3 | 56 | 123 | 0.5 | 52 | 1.1 |
| Example 25 | | | | | | | | | | | | |
| Comparative | — | — | — | HEDP | 2.88 | 0.14 | 3 | 199 | 151 | 1.3 | 64 | 3.1 |
| Example 26 | | | | | | | | | | | | |
| Example 10 | sorbitol | 1.8 | 0.1 | HEDP | 2.88 | 0.14 | 10 | 262 | 226 | 1.2 | 142 | 1.8 |
| Comparative | sorbitol | 1.8 | 0.1 | — | — | — | 10 | 70 | 41 | 1.7 | 38 | 1.8 |
| Example 27 | | | | | | | | | | | | |
| Comparative | — | — | — | HEDP | 2.88 | 0.14 | 10 | 182 | 228 | 0.8 | 141 | 1.3 |
| Example 28 | | | | | | | | | | | | |

TABLE 5

| | organic compound | | | brittle film forming agent | | | | GST | TEOS | | SiN | |
|---|---|---|---|---|---|---|---|---|---|---|---|---|
| | | content | concen- | | content | concen- | | polishing | polishing | GST/ | polishing | GST/ |
| | | (% by | tration | | (% by | tration | | rate | rate | TEOS | rate | SiN |
| | kind | weight) | (mol/L) | kind | weight) | (mol/L) | pH | (Å/min) | (Å/min) | rate ratio | (Å/min) | rate ratio |
| Example 11 | glucose | 1.8 | 0.1 | phosphoric | 1.37 | 0.14 | 3 | 164 | 204 | 0.8 | 56 | 2.9 |
| | | | | acid | | | | | | | | |
| Comparative | glucose | 1.8 | 0.1 | — | — | — | 3 | 62 | 123 | 0.5 | 52 | 1.2 |
| Example 29 | | | | | | | | | | | | |
| Comparative | — | — | — | phosphoric | 1.37 | 0.14 | 3 | 89 | 204 | 0.4 | 58 | 1.5 |
| Example 30 | | | | acid | | | | | | | | |
| Example 12 | glucose | 1.8 | 0.1 | phosphoric | 1.37 | 0.14 | 10 | 182 | 191 | 1.0 | 124 | 1.5 |
| | | | | acid | | | | | | | | |
| Comparative | glucose | 1.8 | 0.1 | — | — | — | 10 | 78 | 39 | 2.0 | 38 | 2.1 |
| Example 31 | | | | | | | | | | | | |
| Comparative | — | — | — | phosphoric | 1.37 | 0.14 | 10 | 130 | 191 | 0.7 | 128 | 1.0 |
| Example 32 | | | | acid | | | | | | | | |

TABLE 6

| | organic compound | | | brittle film forming agent | | | | GST | TEOS | | SiN | |
|---|---|---|---|---|---|---|---|---|---|---|---|---|
| | | content | concen- | | content | concen- | | polishing | polishing | GST/ | polishing | GST/ |
| | | (% by | tration | | (% by | tration | | rate | rate | TEOS | rate | SiN |
| | kind | weight) | (mol/L) | kind | weight) | (mol/L) | pH | (Å/min) | (Å/min) | rate ratio | (Å/min) | rate ratio |
| Example 13 | glucosamine | 1.8 | 0.1 | glycolic acid | 0.76 | 0.1 | 3 | 156 | 116 | 1.3 | 42 | 3.7 |
| Comparative | glucosamine | 1.8 | 0.1 | — | — | — | 3 | 66 | 128 | 0.5 | 51 | 1.3 |
| Example 33 | | | | | | | | | | | | |
| Comparative | — | — | — | glycolic acid | 0.76 | 0.1 | 3 | 120 | 117 | 1.0 | 43 | 2.8 |
| Example 34 | | | | | | | | | | | | |
| Example 14 | glucosamine | 1.8 | 0.1 | glycolic acid | 0.76 | 0.1 | 10 | 224 | 119 | 1.9 | 86 | 2.6 |
| Comparative | glucosamine | 1.8 | 0.1 | — | — | — | 10 | 84 | 52 | 1.6 | 35 | 2.4 |
| Example 35 | | | | | | | | | | | | |
| Comparative | — | — | — | glycolic acid | 0.76 | 0.1 | 10 | 203 | 118 | 1.7 | 68 | 3.0 |
| Example 36 | | | | | | | | | | | | |

TABLE 7

| | organic compound | | | brittle film forming agent | | | | GST | TEOS | | SiN | |
|---|---|---|---|---|---|---|---|---|---|---|---|---|
| | | content | concen- | | content | concen- | | polishing | polishing | GST/ | polishing | GST/ |
| | | (% by | tration | | (% by | tration | | rate | rate | TEOS | rate | SiN |
| | kind | weight) | (mol/L) | kind | weight) | (mol/L) | pH | (Å/min) | (Å/min) | rate ratio | (Å/min) | rate ratio |
| Example 15 | carboxymethyl | 0.1 | 0.00002 | acetic acid | 0.84 | 0.14 | 3 | 138 | 100 | 1.4 | 52 | 2.7 |
| | cellulose | | | | | | | | | | | |
| | (CMC) | | | | | | | | | | | |
| Comparative | carboxymethyl | 0.1 | 0.00002 | — | — | — | 3 | 55 | 136 | 0.4 | 38 | 1.4 |
| Example 37 | cellulose | | | | | | | | | | | |
| | (CMC) | | | | | | | | | | | |
| Comparative | — | — | — | acetic acid | 0.84 | 0.14 | 3 | 82 | 98 | 0.8 | 49 | 1.7 |
| Example 38 | | | | | | | | | | | | |
| Example 16 | carboxymethyl | 0.1 | 0.00002 | acetic acid | 0.84 | 0.14 | 10 | 232 | 145 | 1.6 | 84 | 2.8 |
| | cellulose | | | | | | | | | | | |
| | (CMC) | | | | | | | | | | | |
| Comparative | carboxymethyl | 0.1 | 0.00002 | — | — | — | 10 | 68 | 53 | 1.3 | 32 | 2.1 |
| Example 39 | cellulose | | | | | | | | | | | |
| | (CMC) | | | | | | | | | | | |
| Comparative | — | — | — | acetic acid | 0.84 | 0.14 | 10 | 181 | 131 | 1.4 | 86 | 2.1 |
| Example 40 | | | | | | | | | | | | |

TABLE 8

| | organic compound | | | agent having a chelating action | | | | GST | TEOS | | SiN | |
|---|---|---|---|---|---|---|---|---|---|---|---|---|
| | | content | concen- | | content | concen- | | polishing | polishing | GST/ | polishing | GST/ |
| | | (% by | tration | | (% by | tration | | rate | rate | TEOS | rate | SiN |
| | kind | weight) | (mol/L) | kind | weight) | (nnol/L) | pH | (Å/min) | (Å/min) | rate ratio | (Å/min) | rate ratio |
| Example 17 | dextrin | 0.1 | 0.001 | iminodiacetic | 1.86 | 0.14 | 3 | 189 | 134 | 1.4 | 52 | 3.6 |
| | | | | acid | | | | | | | | |
| Comparative | dextrin | 0.1 | 0.001 | — | — | — | 3 | 48 | 129 | 0.4 | 51 | 0.9 |
| Example 41 | | | | | | | | | | | | |
| Comparative | — | — | — | iminodiacetic | 1.86 | 0.14 | 3 | 156 | 132 | 1.2 | 51 | 3.1 |
| Example 42 | | | | acid | | | | | | | | |
| Example 18 | dextrin | 0.1 | 0.001 | iminodiacetic | 1.86 | 0.14 | 10 | 141 | 152 | 0.9 | 82 | 1.7 |
| | | | | acid | | | | | | | | |
| Comparative | dextrin | 0.1 | 0.001 | — | — | — | 10 | 52 | 46 | 1.1 | 38 | 1.4 |
| Example 43 | | | | | | | | | | | | |
| Comparative | — | — | — | iminodiacetic | 1.86 | 0.14 | 10 | 98 | 148 | 0.7 | 78 | 1.3 |
| Example 44 | | | | acid | | | | | | | | |

As is clear from Tables 2 to 8 above, it has been found that the polishing composition of the present invention shown in Examples has a high polishing rate of a GST alloy which is a phase-change compound, and also has high polishing selectivity of the GST alloy.

The present application is based on the Japanese patent application No. 2013-103244 filed on May 15, 2013. The disclosed contents thereof are referred to and incorporated here as a whole.

1. A polishing composition comprising:
an organic compound having three or more hydroxy groups;
at least one of an agent having a chelating action to at least one component of a phase-change compound and a brittle film forming agent; and
an oxidizing agent.

2. The polishing composition according to claim 1, wherein the polishing composition is used for polishing a polishing object including a layer containing a phase-change compound.

3. The polishing composition according to claim 1, wherein the phase-change compound is a germanium (Ge)-antimony (Sb)-tellurium (Te) alloy.

4. A method for polishing a surface of a polishing object containing a phase-change compound using the polishing composition according to claim 1.

5. A method for manufacturing a substrate containing a phase-change compound, comprising polishing by the method according to claim 4.
